(19) United States
(12) Patent Application Publication
(10) Pub. No.: US 2025/0293358 A1
(43) Pub. Date: Sep. 18, 2025

(54) POWER STORAGE CELL AND METHOD FOR MANUFACTURING POWER STORAGE CELL

(71) Applicants: TOYOTA JIDOSHA ABUSHIKI KAISHA, Toyota-shi (JP); TOYOTA BATTERY CO., LTD., Kosai-shi (JP)

(72) Inventors: Masato ONO, Nagoya-shi (JP); Masahiro ISHIZUKA, Toyota-shi (JP); Atsushi SUGIHARA, Toyota-shi (JP); Yuka YOKOI, Nagoya-shi (JP); Keitaro MACHIDA, Hamamatsu-shi (JP); Ryosuke SATO, Toyota-shi (JP); Tatsuya YAMAMOTO, Toyohashi-shi (JP)

(73) Assignees: TOYOTA JIDOSHA ABUSHIKI KAISHA, Toyota-shi (JP); TOYOTA BATTERY CO., LTD., Kosai-shi (JP)

(21) Appl. No.: 19/040,444

(22) Filed: Jan. 29, 2025

(30) Foreign Application Priority Data
Mar. 18, 2024 (JP) 2024-042044

(51) Int. Cl. H01M 50/178; H01M 10/04; H01M 50/105; H01M 50/474; H01M 50/477

(52) U.S. Cl. CPC H01M 50/178; H01M 10/0431; H01M 50/105; H01M 50/474; H01M 50/477

(57) ABSTRACT

A power storage cell includes: a pair of electrode bodies each having an electrode tab and disposed to face each other; an interposed member made of an insulating material and disposed between the electrode tabs of the pair of electrode bodies; a laminate exterior body that accommodates the pair of electrode bodies and the interposed member; a conductive film provided on surfaces of the interposed member and connected to each of the electrode tabs; and a current collector terminal that is connected to the conductive film and protrudes from the laminate exterior body.

### CROSS REFERENCE TO RELATED APPLICATIONS

This nonprovisional application is based on Japanese Patent Application No. 2024-042044 filed on Mar. 18, 2024 with the Japan Patent Office, the entire contents of which are hereby incorporated by reference.

### BACKGROUND

### Field

The present disclosure relates to a power storage cell and a method for manufacturing the power storage cell.

### Description of the Background Art

For example, Japanese National Patent Publication No. 2023-525907 discloses a battery including a plurality of electrode body assemblies and a case that accommodates the plurality of electrode body assemblies. Each electrode body assembly includes a pair of electrode bodies adjacent to each other, an insulating spacer, a tab support member formed in a rectangular tube shape, an electrode drawing-out member, and a sealing film. Each electrode body has an electrode body main body and a tab. The insulating spacer is disposed between a pair of the tabs adjacent to each other. The insulating spacer is fixed to a third surface of the tab support member. The tab is connected to a first surface of the tab support member. The electrode drawing-out member is connected to a fourth surface of the tab support member and protrudes from the sealing film.

### SUMMARY

In the battery described in Japanese National Patent Publication No. 2023-525907, the structure for drawing out the electrode drawing-out member to the outside of the sealing film is complicated.

An object of the present disclosure is to provide a power storage cell that can reduce the number of components, and a method for manufacturing the power storage cell.

A power storage cell according to one aspect of the present disclosure includes: a pair of electrode bodies each having an electrode tab and disposed to face each other; an interposed member made of an insulating material and disposed between the electrode tabs of the pair of electrode bodies; a laminate exterior body that accommodates the pair of electrode bodies and the interposed member; a conductive film provided on surfaces of the interposed member and connected to each of the electrode tabs; and a current collector terminal that is connected to the conductive film and protrudes from the laminate exterior body.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage cell according to one embodiment of the present disclosure.

FIG. 2 is an exploded perspective view of the power storage cell shown in FIG. 1.

FIG. 3 is an exploded perspective view of a cell unit.

FIG. 4 is a front view of the power storage cell.

FIG. 5 is a cross sectional view taken along a line V-V in FIG. 4.

FIG. 6 is a cross sectional view taken along a line VI-VI in FIG. 4.

FIG. 7 is a cross sectional view schematically showing a method for manufacturing an interposed member and a conductive film.

FIG. 8 is a cross sectional view schematically showing a modification of the interposed member.

FIG. 9 is a cross sectional view schematically showing modifications of the conductive film and a current collector terminal.

FIG. 10 is a cross sectional view schematically showing a modification of the method for manufacturing the interposed member and the conductive film.

FIG. 11 is a cross sectional view schematically showing a modification of the cell unit.

### DESCRIPTION OF THE PREFERRED EMBODIMENTS

An embodiment of the present disclosure will be described with reference to the drawings. It should be noted that, in the drawings referred to below, the same or corresponding members will be designated by the same reference numerals.

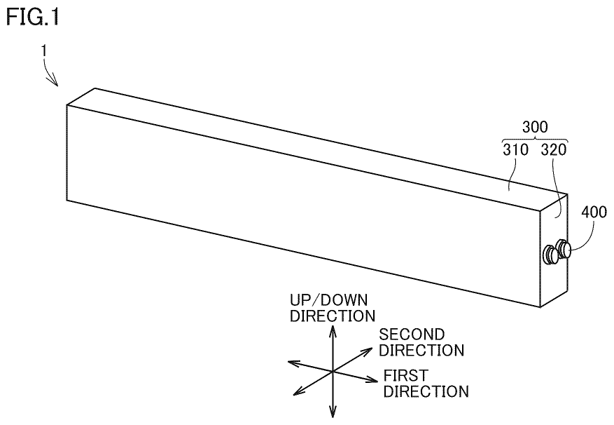

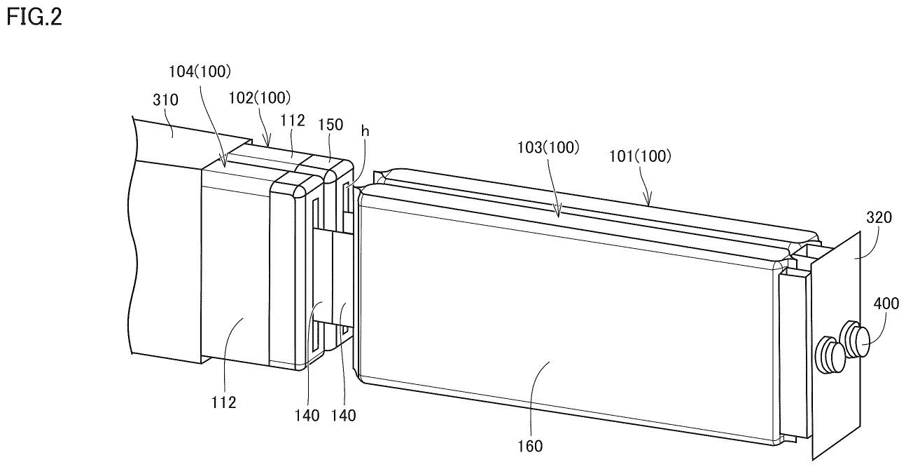

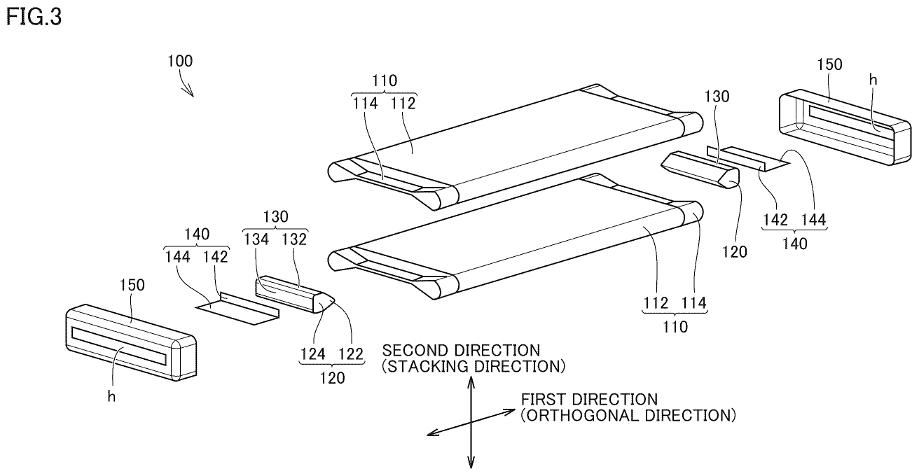

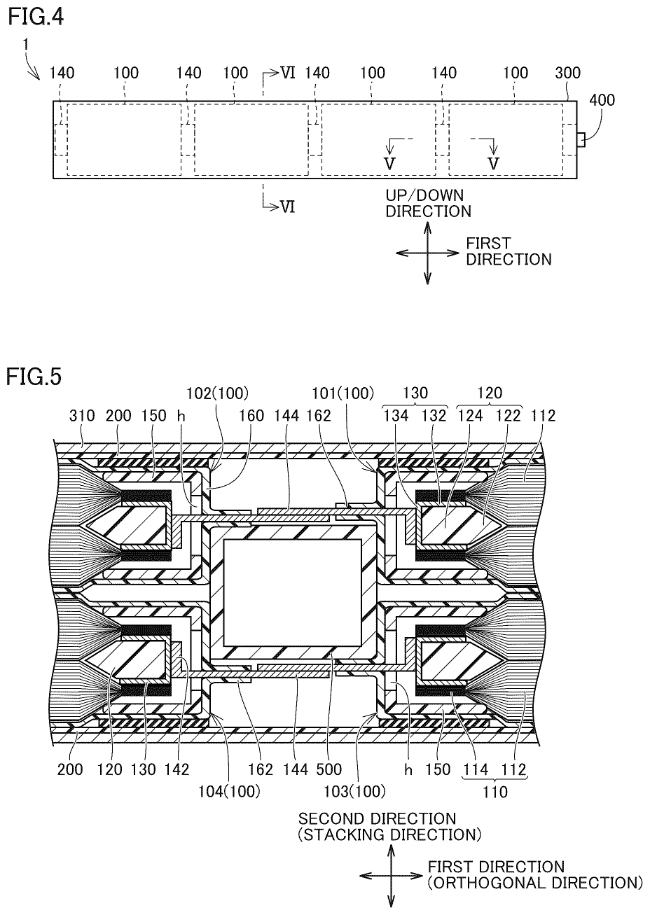

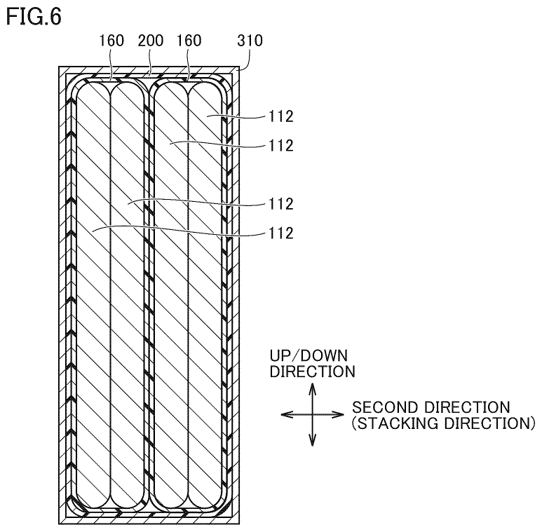

FIG. 1 is a perspective view schematically showing a power storage cell according to one embodiment of the present disclosure. FIG. 2 is an exploded perspective view of the power storage cell shown in FIG. 1. FIG. 3 is an exploded perspective view of a cell unit. FIG. 4 is a front view of the power storage cell. FIG. 5 is a cross sectional view taken along a line V-V in FIG. 4. FIG. 6 is a cross sectional view taken along a line VI-VI in FIG. 4. A power storage cell 1 is mounted on a bottom portion of a vehicle, for example.

As shown in FIGS. 1 to 6, power storage cell 1 includes a plurality of cell units 100, a covering sheet 200 (see FIGS. 5 and 6), a cell case 300, and external terminals 400. It should be noted that illustration of covering sheet 200 is omitted in FIG. 2.

The plurality of cell units 100 include a first cell unit 101, a second cell unit 102, a third cell unit 103, and a fourth cell unit 104. In the present embodiment, the plurality of cell units 100 include eight cell units 100. However, the number of cell units 100 is not limited to eight. Each cell unit 100 may be a lithium-ion battery, for example. Each cell unit 100 may be constituted by a so-called all-solid-state battery containing a solid electrolyte.

First cell unit 101 is connected to second cell unit 102. Third cell unit 103 is connected to fourth cell unit 104. First cell unit 101 and second cell unit 102 are arranged in a first direction, and first cell unit 101 and third cell unit 103 are adjacent to each other in a second direction orthogonal to both the first direction and an up/down direction. Second cell unit 102 and fourth cell unit 104 are adjacent to each other in the second direction. Each cell unit 100 has a shape that extends longer in the first direction than in the second direction and extends longer in the first direction than in the up/down direction. Each cell unit 100 has a shape that extends longer in the up/down direction than in the second direction.

FIG. 3 is an exploded perspective view of cell unit 100. Each cell unit 100 has at least one electrode body 110, an interposed member 120, a conductive film 130, a current collector terminal 140, a cover 150, and a laminate exterior body 160. It should be noted that illustration of laminate exterior body 160 is omitted in FIG. 3. Further, laminate exterior body 160 of second cell unit 102 and laminate exterior body 160 of fourth cell unit 104 are omitted in FIG. 2.

The at least one electrode body 110 includes two electrode bodies 110. However, the number of electrode bodies 110 is not limited to two. Each electrode body 110 is constituted by a wound body in which a positive electrode sheet and a negative electrode sheet are wound with a separator being interposed therebetween. However, each electrode body 110 may be constituted by a stacked body in which a positive electrode sheet and a negative electrode sheet are stacked with a separator being interposed therebetween. The two electrode bodies 110 are adjacent to each other in a stacking direction (an up/down direction in FIG. 5) in which the positive electrode sheet and the negative electrode sheet are stacked on each other. Each electrode body 110 is formed in a shape elongated in an orthogonal direction orthogonal to both the stacking direction and the up/down direction. The stacking direction (a thickness direction) corresponds to the second direction, and the orthogonal direction corresponds to the first direction.

Each electrode body 110 has a coated portion 112 and an electrode tab 114. Coated portion 112 is an area of an electrode foil in the positive electrode sheet or the negative electrode sheet where an active material layer is provided. Electrode tab 114 is an area of the electrode foil in the positive electrode sheet or the negative electrode sheet where the active material layer is not provided, that is, an uncoated portion where the electrode foil is exposed. Electrode tab 114 protrudes from coated portion 112 in the orthogonal direction. A pair of electrode tabs 114 that face each other in the stacking direction have the same polarity.

Interposed member 120 is disposed between the pair of electrode tabs 114 adjacent to each other in the stacking direction. Interposed member 120 is made of an insulating material (such as a synthetic resin). As shown in FIGS. 3 and 5, interposed member 120 has a spacer portion 122 and a support portion 124.

Spacer portion 122 is adjacent to a boundary portion between a pair of coated portions 112 adjacent to each other, in the orthogonal direction, and is adjacent to the pair of electrode tabs 114 adjacent to each other, in the stacking direction. Spacer portion 122 has a shape in which a dimension in the stacking direction gradually increases with increase in distance from the boundary portion between the pair of coated portions 112, in the orthogonal direction. Spacer portion 122 is formed in a substantially triangular prism shape.

Support portion 124 supports each electrode tab 114. Support portion 124 protrudes outward in the orthogonal direction from spacer portion 122. Support portion 124 is formed integrally with spacer portion 122 using the same material as that for spacer portion 122. Support portion 124 is formed in a substantially rectangular prism shape.

Conductive film 130 is made of a metal (such as copper or aluminum). Conductive film 130 is provided on surfaces of interposed member 120. Conductive film 130 is connected to each electrode tab 114. Conductive film 130 has a pair of connection base portions 132 and a coupling portion 134.

Each connection base portion 132 is a portion connected to electrode tab 114. Each connection base portion 132 is provided between support portion 124 and electrode tab 114. Each connection base portion 132 covers an outer surface of support portion 124 in the stacking direction.

Coupling portion 134 couples the pair of connection base portions 132. Coupling portion 134 covers an outer surface of support portion 124 in the orthogonal direction. The thickness of coupling portion 134 may be the same as or different from the thickness of each connection base portion 132.

Current collector terminal 140 is connected to conductive film 130. Current collector terminal 140 electrically connected to electrode tab 114 of a positive electrode via conductive film 130 is made of aluminum, for example. Current collector terminal 140 electrically connected to electrode tab 114 of a negative electrode via conductive film 130 is made of copper, for example. Current collector terminal 140 has a connection portion 142 and a protruding portion 144.

Connection portion 142 is connected to coupling portion 134 by welding or the like. Connection portion 142 is formed in a flat plate shape. The thickness of connection portion 142 may be larger than the thickness of conductive film 130.

Protruding portion 144 protrudes outward in the orthogonal direction from connection portion 142. Protruding portion 144 is formed in a flat plate shape. The thickness of protruding portion 144 may be larger than the thickness of conductive film 130. As shown in FIG. 5, protruding portion 144 of current collector terminal 140 in first cell unit 101 is connected to protruding portion 144 of current collector terminal 140 in second cell unit 102. Similarly, protruding portion 144 of current collector terminal 140 in third cell unit 103 is connected to protruding portion 144 of current collector terminal 140 in fourth cell unit 104.

As shown in FIG. 5, an insulating member 500 may be disposed between a connection portion between protruding portion 144 in first cell unit 101 and protruding portion 144 in second cell unit 102, and a connection portion between protruding portion 144 in third cell unit 103 and protruding portion 144 in fourth cell unit 104.

Cover 150 covers an end portion of electrode body 110 in the orthogonal direction, more specifically, electrode tab 114. Cover 150 is made of an insulating material (such as a synthetic resin). As shown in FIGS. 2, 3, and 5, cover 150 is provided with a through hole h through which protruding portion 144 is inserted.

Laminate exterior body 160 accommodates each electrode body 110, interposed member 120, conductive film 130, a portion of current collector terminal 140, and cover 150. Laminate exterior body 160 is made of a laminate film. As shown in FIG. 5, laminate exterior body 160 has an edge portion 162. Edge portion 162 is formed by connecting (welding) the laminate films. Protruding portion 144 protrudes outward in the orthogonal direction from edge portion 162 of laminate exterior body 160.

Covering sheet 200 (see FIGS. 5 and 6) covers the plurality of cell units 100. More specifically, covering sheet 200 covers the plurality of cell units 100 to surround these cell units 100 together. Covering sheet 200 is made of an insulating material (such as a synthetic resin).

Cell case 300 accommodates the plurality of cell units 100 and covering sheet 200. Cell case 300 is made of aluminum, for example. Cell case 300 is formed in a rectangular parallelepiped shape elongated in the first direction. As shown in FIGS. 1 and 2, cell case 300 has a case main body 310 and a lid 320.

Case main body 310 is formed in a rectangular tube shape elongated in the first direction. Case main body 310 surrounds the plurality of cell units 100 and covering sheet 200.

Lid 320 is connected to case main body 310 by welding or the like, to close an opening in case main body 310.

External terminals 400 are provided on lid 320. External terminals 400 are connected to current collector terminals 140 in cell units 100 disposed at positions closest to lid 320, of the plurality of cell units 100.

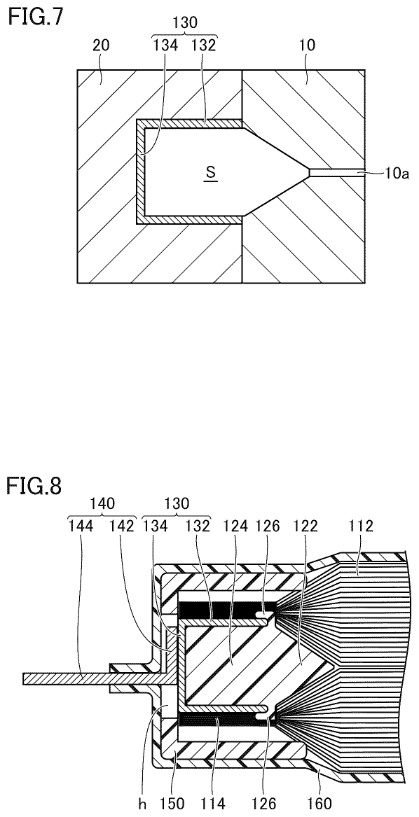

Next, a method for manufacturing interposed member 120 and conductive film 130 will be described with reference to FIG. 7. Interposed member 120 and conductive film 130 are integrally formed by insert molding. Specifically, the manufacturing method has a preparing step, a disposing step, and a filling step.

In the preparing step, a first mold 10 and a second mold 20 are prepared, which can be in contact with or spaced apart from each other and have a space S corresponding to interposed member 120 in a state of being in contact with each other. First mold 10 has a supply port 10a for supplying the insulating material for forming interposed member 120 into space S.

In the disposing step, conductive film 130 is disposed within second mold 20.

In the filling step, space S is filled with the insulating material for forming interposed member 120, in a state in which conductive film 130 is disposed within second mold 20, to integrally form conductive film 130 and interposed member 120.

As described above, in power storage cell 1 according to the present embodiment, since electrode tab 114 and current collector terminal 140 are electrically connected via conductive film 130 provided on the surfaces of interposed member 120, the structure for drawing out current collector terminal 140 is simplified.

Hereinafter, modifications of the embodiment described above will be described.

### <First Modification>

As shown in FIG. 8, interposed member 120 may have a covering portion 126. Covering portion 126 covers an edge portion of connection base portion 132. Covering portion 126 is provided at a boundary portion between spacer portion 122 and support portion 124.

In this aspect, detachment of connection base portion 132 from support portion 124 is suppressed.

### <Second Modification>

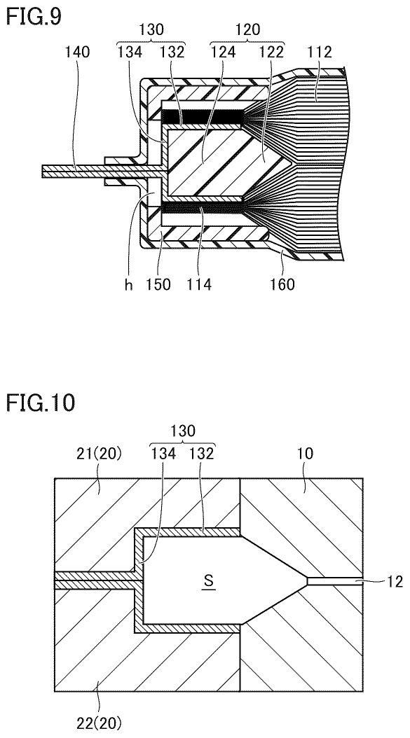

As shown in FIG. 9, current collector terminal 140 may be formed integrally with conductive film 130 using the same material as that for conductive film 130.

In this case, as shown in FIG. 10, second mold 20 may have a first split mold 21 and a second split mold 22 that can be separated from each other.

In this aspect, detachment of current collector terminal 140 from conductive film 130 is suppressed, as compared with a case where current collector terminal 140 is constituted by a member different from conductive film 130.

### <Third Modification>

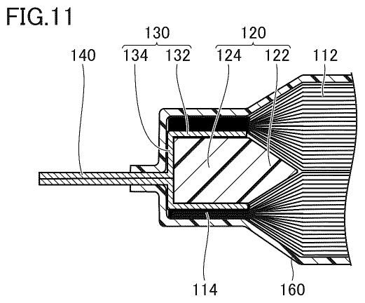

As shown in FIG. 11, cover 150 may be omitted. In this example, laminate exterior body 160 is in contact with coupling portion 134.

It will be understood by those skilled in the art that the exemplary embodiment described above is a specific example of the following aspects.

### [Aspect 1]

A power storage cell including:
a pair of electrode bodies each having an electrode tab and disposed to face each other;
an interposed member made of an insulating material and disposed between the electrode tabs of the pair of electrode bodies;
a laminate exterior body that accommodates the pair of electrode bodies and the interposed member;
a conductive film provided on surfaces of the interposed member and connected to each of the electrode tabs; and
a current collector terminal that is connected to the conductive film and protrudes from the laminate exterior body.

In the power storage cell, since the electrode tab and the current collector terminal are electrically connected via the conductive film provided on the surfaces of the interposed member, the number of components is reduced.

### [Aspect 2]

The power storage cell according to aspect 1, wherein the current collector terminal is formed integrally with the conductive film using a same material as that for the conductive film.

In this aspect, detachment of the current collector terminal from the conductive film is suppressed, as compared with a case where the current collector terminal is constituted by a member different from the conductive film. Further, the step of connecting the current collector terminal to the conductive film is omitted.

### [Aspect 3]

The power storage cell according to aspect 1, wherein
each of the electrode bodies further has a coated portion including an electrode foil and an active material layer provided on the electrode foil,
each of the electrode tabs protrudes from the coated portion in an orthogonal direction orthogonal to a stacking direction in which the pair of electrode bodies face each other,
a pair of the electrode tabs that face each other in the stacking direction have a same polarity,
the interposed member has
   a spacer portion that is adjacent to a boundary portion between a pair of the coated portions adjacent to each other, in the orthogonal direction, and is adjacent to the pair of the electrode tabs adjacent to each other, in the stacking direction, and
   a support portion that protrudes outward in the orthogonal direction from the spacer portion and supports each of the electrode tabs, and
the spacer portion has a shape in which a dimension in the stacking direction gradually increases with increase in distance from the boundary portion between the pair of the coated portions adjacent to each other, in the orthogonal direction.

In this aspect, the distance between the pair of the electrode tabs adjacent to each other is ensured by the spacer portion, and each electrode tab is effectively supported by the support portion. Further, breakage of the electrode tab due to the contact of the spacer portion with the electrode tab is suppressed.

### [Aspect 4]

The power storage cell according to aspect 3, wherein
the conductive film has
   a pair of connection base portions that cover outer surfaces of the support portion in the stacking direction and are connected to the electrode tabs, and
   a coupling portion that covers an outer surface of the support portion in the orthogonal direction and couples the pair of connection base portions, and
the current collector terminal is connected to the coupling portion.

### [Aspect 5]

The power storage cell according to aspect 4, wherein the interposed member has a covering portion that covers an edge portion of the connection base portion.

In this aspect, detachment of the connection base portion from the support portion is suppressed.

### [Aspect 6]

A method for manufacturing the power storage cell according to any one of aspects 1 to 5, the method including:
a disposing step of disposing the conductive film within a first mold and a second mold that can be in contact with or spaced apart from each other and have a space corresponding to the interposed member in a state of being in contact with each other; and
a filling step of filling the space with an insulating material for forming the interposed member, in a state in which the conductive film is disposed within the first mold and the second mold, to integrally form the conductive film and the interposed member.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A power storage cell comprising:
a pair of electrode bodies each having an electrode tab and disposed to face each other;
an interposed member made of an insulating material and disposed between the electrode tabs of the pair of electrode bodies;
a laminate exterior body that accommodates the pair of electrode bodies and the interposed member;
a conductive film provided on surfaces of the interposed member and connected to each of the electrode tabs; and
a current collector terminal that is connected to the conductive film and protrudes from the laminate exterior body.

2. The power storage cell according to claim 1, wherein the current collector terminal is formed integrally with the conductive film using a same material as that for the conductive film.

3. The power storage cell according to claim 1, wherein
each of the electrode bodies further has a coated portion including an electrode foil and an active material layer provided on the electrode foil,
each of the electrode tabs protrudes from the coated portion in an orthogonal direction orthogonal to a stacking direction in which the pair of electrode bodies face each other,
a pair of the electrode tabs that face each other in the stacking direction have a same polarity,
the interposed member has
a spacer portion that is adjacent to a boundary portion between a pair of the coated portions adjacent to each other, in the orthogonal direction, and is adjacent to the pair of the electrode tabs adjacent to each other, in the stacking direction, and
a support portion that protrudes outward in the orthogonal direction from the spacer portion and supports each of the electrode tabs, and
the spacer portion has a shape in which a dimension in the stacking direction gradually increases with increase in distance from the boundary portion between the pair of the coated portions adjacent to each other, in the orthogonal direction.

4. The power storage cell according to claim 3, wherein
the conductive film has
a pair of connection base portions that cover outer surfaces of the support portion in the stacking direction and are connected to the electrode tabs, and
a coupling portion that covers an outer surface of the support portion in the orthogonal direction and couples the pair of connection base portions, and
the current collector terminal is connected to the coupling portion.

5. The power storage cell according to claim 4, wherein the interposed member has a covering portion that covers an edge portion of the connection base portion.

6. A method for manufacturing the power storage cell according to claim 1, the method comprising:
a disposing step of disposing the conductive film within a first mold and a second mold that can be in contact with or spaced apart from each other and have a space corresponding to the interposed member in a state of being in contact with each other; and
a filling step of filling the space with an insulating material for forming the interposed member, in a state in which the conductive film is disposed within the first mold and the second mold, to integrally form the conductive film and the interposed member.
